(19) United States
(12) Patent Application Publication
(10) Pub. No.: US 2012/0215607 A1
(43) Pub. Date: Aug. 23, 2012

(54) SYSTEMS AND METHODS FOR ALLOCATING A COMMON RESOURCE BASED ON INDIVIDUAL USER PREFERENCES

(76) Inventors: Sean Christopher Brereton, II, Agoura Hills, CA (US); David P. Clark, Thousand Oaks, CA (US); Erin Withers, Thousand Oaks, CA (US); Grant R. Withers, Thousand Oaks, CA (US)

(21) Appl. No.: 13/031,156

(22) Filed: Feb. 18, 2011

(51) Int. Cl. G06Q 99/00; G06Q 30/00

(52) U.S. Cl. 705/14.23; 705/319; 705/329

(57) ABSTRACT

A system and method for allocating a common resource based on individual user preferences. Voting points are awarded to at least one user member of an online community for at least one participation activity. A plurality of recipient members is accepted to the online community. At least one user member selection is received including at least one selected recipient member. A revenue pool is aggregated from at least one revenue-generating activity and any advertising revenue. A donatable pool is determined, where the donatable pool includes at least a portion of the revenue pool for allocating to the plurality of recipient members. The donatable pool is allocated to the plurality of recipient members based on the at least one user member selection.

### BACKGROUND OF THE INVENTION

1. Field of the Invention

Embodiments of the invention described herein pertain to the field of computer systems. More particularly, but not by way of limitation, one or more embodiments of the invention enable systems and methods for allocating a common resource based on individual user preferences.

2. Description of the Related Art

Modern technologies, such as the Internet, have enabled new ways of aggregating resources. For example, advertisement is a major source of revenue derived from Web activities. Payment may be obtained for advertisements that are placed on websites or otherwise displayed to viewers over a network. Online advertising is a complex industry that includes specialized ad servers, multimedia advertisements, placement optimization, demographic targeting, interaction metrics, impression metrics, and other functions and features.

There are many methods for a publisher to receive payment for displaying advertisements. For example, compensation may be received based on the number of impressions of text, banners, or rich media advertisements. Compensation may also be received on a revenue sharing, pay-per-click or pay-per-action scheme.

Publishers can increase the compensation they receive by increasing traffic and participation by users of a web domain. Active participation increases the number of impressions that the publisher can display, and also increases the likelihood of click-throughs, actions and sales. By offering a service that attracts active participation, advertising revenue may be increased.

Some publishers encourage users to generate advertisement revenue based on a common objective. For example, publishers have encouraged users to click through advertisements to raise money to support a service offered, such as a freely available software program, or published works by an author or artist. Publishers have also encouraged users to click through advertisements to raise money to support a specified cause. However, these publishers do not offer a compelling service that inherently attracts active participation. Furthermore, these publishers do not allow the allocation of advertisement revenue based on individual user preferences.

To overcome the problems and limitations described above there is a need for a system and method for allocating a common resource based on individual user preferences.

### BRIEF SUMMARY OF THE INVENTION

One or more embodiments of the invention enable systems and methods for allocating a common resource based on individual user preferences. In one or more embodiments, advertisement revenue is the major component of a common resource that is distributed to charitable organizations. In one or more embodiments, users are offered a service that attracts active participation to increase advertising revenue. In one or more embodiments, the service offered may be shared with other members and non-members to increase viral exposure. Users are further incentivized to participate because the allocation of the common resource is based on individual user preferences. In one or more embodiments, participation increases a weight of a user's preferences regarding the allocation of the common resource.

One or more embodiments of systems and methods for allocating a common resource based on individual user preferences are directed to a computer-readable medium including computer-readable instructions for allocating a common resource based on individual user preferences. Execution of the computer-readable instructions by one or more processors causes the one or more processors to carry out steps.

In one or more embodiments, the steps include awarding voting points to at least one user member of an online community for at least one participation activity related to the online community.

The steps further include accepting a plurality of recipient members to the online community.

The steps further include receiving at least one user member selection including at least one selected recipient member.

The steps further include aggregating a revenue pool from at least one revenue-generating activity and any advertising revenue.

The steps further include determining a donatable pool, where the donatable pool includes at least a portion of the revenue pool for allocating to the plurality of recipient members.

The steps further include allocating the donatable pool to the plurality of recipient members based on the at least one user member selection.

In one or more embodiments, the at least one user member selection further includes at least one user-specified allocation between the at least one selected recipient member, where allocating the donatable pool is further based on the at least one user-specified allocation.

In one or more embodiments, the allocating the donatable pool includes determining a recipient point value for each of the plurality of recipient members based on the at least one user-specified allocation and voting points associated with the at least one user member, where the donatable pool is allocated to the plurality of recipient members based on the recipient point values and a total number of voting points awarded.

In one or more embodiments, the steps further include awarding currency points to the at least one user member of the online community for at least one revenue-generating activity related to the online community, where a number of currency points awarded for a selected revenue-generating activity is based on revenue generated by the selected revenue-generating activity. The at least one user member may redeem the currency points as at least partial payment for at least one paid service or product available through the online community.

In one or more embodiments, the at least one revenue-generating activity includes at least one of corporate sponsorships, donations, auctions, charity drive participation, raffles, selling merchandise, and purchasing merchandise.

In one or more embodiments, the at least one participation activity includes at least one of registration, profile generation, profile completion, providing demographic information, generating content, participating in surveys, referring at least one new user member, and referring at least one new recipient member.

In one or more embodiments, the online community includes a media sharing network, and the steps further include providing a media sharing module through the online community. The media sharing module is configured to perform the steps of receiving at least one media file from a selected user member, storing the at least one media file in association with the selected user member, and providing the at least one media file in association with the selected user member. In one or more embodiments, the at least one media file includes at least one photograph.

The at least one participation activity may include at least one of uploading media, sharing media and managing media. The at least one revenue-generating activity may include at least one of selling a representation of one or more selected media files, purchasing a representation of the one or more selected media files, selling merchandise customized with the one or more selected media files, and purchasing merchandise customized with the one or more selected media files. The at least one participation activity may include associating one or more selected media files with one or more recipient members.

In one or more embodiments, the steps further include providing at least one microsite for at least one of the plurality of recipient members.

In one or more embodiments, the steps further include providing at least one microsite for at least one user member.

In one or more embodiments, the plurality of recipient members includes at least one non-profit organization, where the at least one selected recipient member includes at least one selected non-profit organization, and where the online community is configured to enable the user members to contribute to the at least one selected non-profit organization.

In one or more embodiments, the steps further include receiving at least one opportunity description from the at least one non-profit organization, and providing the at least one opportunity description to the user members through the online community. The at least one opportunity description may include at least one of non-profit events, donation drives, fundraisers and volunteering opportunities.

In one or more embodiments, the online community is configured to enable the user members to contribute to the at least one selected non-profit organization by at least one of direct donation, volunteering, viewing advertising content provided through the online community, engaging in the at least one participation activity, and engaging in the at least one revenue-generating activity.

In one or more embodiments, the steps further include providing donation information and donation regulations to at least one entity donor, accepting at least one target non-profit organization from the at least one entity donor, accepting at least one donation to the at least one target non-profit organization, validating the at least one donation based on the donation regulations, and providing documentation regarding the at least one donation to the at least one entity donor.

One or more embodiments of systems and methods for allocating a common resource based on individual user preferences are directed to a computer-readable medium for participation in allocating a common resource to a plurality of non-profit organizations through online community including computer-readable instructions. Execution of the computer-readable instructions by one or more processors causes the one or more processors to carry out steps.

The steps include connecting to an online community.

The steps further include accessing a list of registered non-profit organizations registered with the online community.

The steps further include selecting at least one selected non-profit organization from the registered non-profit organizations.

The steps further include earning voting points for at least one participation activity related to the online community.

The voting points are used to determine an allocation of a donatable pool for donation to at least one of the registered non-profit organizations, where the donatable pool includes at least a portion of a revenue pool generated by revenue-generating activities associated with the online community.

In one or more embodiments, the steps further include selecting one or more third-party social media network, where information is shared between the online community and the one or more third-party social media network.

One or more embodiments of systems and methods for allocating a common resource based on individual user preferences are directed to a computer-implemented method for enabling individuals to collectively contribute to non-profit organizations.

In one or more embodiments, the computer-implemented method includes the step of registering at least one non-profit organization to an online community configured to enable at least one user member to contribute to the at least one non-profit organization.

In one or more embodiments, the computer-implemented method further includes the step of registering the at least one user member.

In one or more embodiments, the computer-implemented method further includes the step of receiving at least one user member selection including at least one selected non-profit organization.

In one or more embodiments, the computer-implemented method further includes the step of awarding voting points to the at least one user member for at least one participation activity related to the online community. The at least one participation activity may include at least one of registration, profile generation, profile completion, providing demographic information, generating content, participating in surveys, referring at least one new user member, and referring at least one new non-profit organization.

In one or more embodiments, the computer-implemented method further includes the step of aggregating a revenue pool from at least one revenue-generating activity and any advertising revenue.

In one or more embodiments, the computer-implemented method further includes the step of determining a donatable pool. The donatable pool may include at least a portion of the revenue pool for allocating to the at least one non-profit organization.

In one or more embodiments, the computer-implemented method further includes the step of allocating the donatable pool to the at least one non-profit organization based on the at least one user member selection.

In one or more embodiments, the computer-implemented method further includes the step of awarding currency points to the at least one user member for at least one revenue-generating activity related to the online community, where a number of currency points awarded for a selected revenue-generating activity is based on revenue generated by the selected revenue-generating activity. The at least one revenue-generating activity may include at least one of corporate sponsorships, donations, auctions, charity drive participation, raffles, selling merchandise, and purchasing merchandise.

In one or more embodiments, the computer-implemented method further includes the step of allowing the at least one user member to redeem the currency points as at least partial payment for at least one paid service or product available through the online community.

In one or more embodiments, the computer-implemented method further includes the step of providing a media sharing module through the online community, where the media sharing module is configured to receive, store and share at least one media file associated with at least one of the at least one user member or non-profit organization. The at least one participation activity may include at least one of uploading media, sharing media and managing media.

In one or more embodiments, the computer-implemented method further includes the step of receiving at least one opportunity description from the at least one non-profit organization. The at least one opportunity description may include at least one of non-profit events, donation drives and volunteering opportunities.

In one or more embodiments, the computer-implemented method further includes the step of providing the at least one opportunity description to the user members through the online community.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that, when programmed as described herein, may operate as a specially programmed computer capable of implementing one or more methods, apparatus and/or systems in accordance with systems and methods for allocating a common resource based on individual user preferences.

FIG. 2 illustrates an exemplary system diagram in accordance with systems and methods for allocating a common resource based on individual user preferences.

FIG. 3 illustrates a flow chart of an exemplary method for allocating a common resource to at least one recipient member in accordance with systems and methods for allocating a common resource based on individual user preferences.

FIG. 4 illustrates a flow chart of an exemplary method for allocating a common resource to at least one non-profit organization in accordance with systems and methods for allocating a common resource based on individual user preferences.

FIG. 5 illustrates a flow chart of an exemplary method for facilitating an entity donor donation in accordance with systems and methods for allocating a common resource based on individual user preferences.

FIG. 6 illustrates a flow chart of an exemplary method for participation in allocating a common resource for a plurality of non-profit organizations through an online community in accordance with systems and methods for allocating a common resource based on individual user preferences.

FIG. 7 illustrates a flow chart of an exemplary method for enabling individuals to collectively contribute to non-profit organizations in accordance with systems and methods for allocating a common resource based on individual user preferences.

FIG. 8 illustrates an exemplary user interface for registering a recipient member in accordance with systems and methods for allocating a common resource based on individual user preferences.

FIGS. 9A-9B illustrate an exemplary user interface for registering a recipient member in accordance with systems and methods for allocating a common resource based on individual user preferences.

FIG. 10 illustrates an exemplary microsite for a recipient member in accordance with systems and methods for allocating a common resource based on individual user preferences.

FIG. 11 illustrates an exemplary user interface for navigating a recipient member directory in accordance with systems and methods for allocating a common resource based on individual user preferences.

FIG. 12 illustrates an exemplary user interface provided to a user member in accordance with systems and methods for allocating a common resource based on individual user preferences.

FIG. 13 illustrates an exemplary media sharing module in accordance with systems and methods for allocating a common resource based on individual user preferences.

FIG. 14 illustrates an exemplary display showing user member participation information in accordance with systems and methods for allocating a common resource based on individual user preferences.

### DETAILED DESCRIPTION

One or more embodiments of systems and methods for allocating a common resource based on individual user preferences will now be described. In the following exemplary description, numerous specific details are set forth in order to provide a more thorough understanding of embodiments of the invention. It will be apparent, however, to one of ordinary skill in the art that the systems and methods described may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims and the full scope of any equivalents are what define the metes and bounds of the invention.

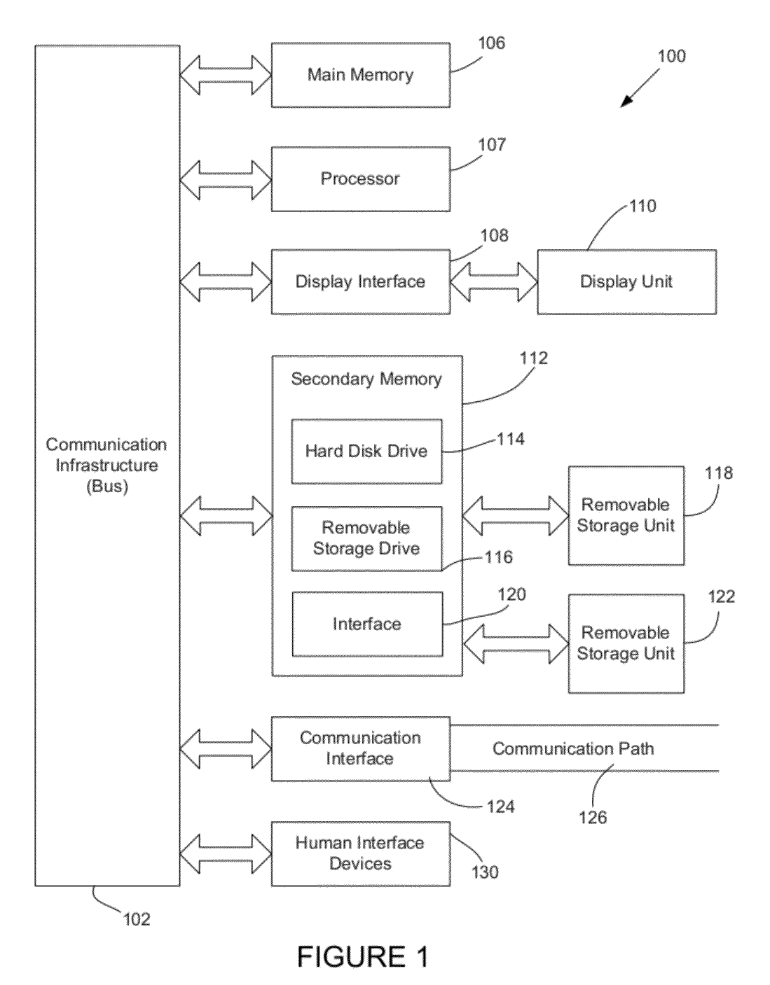

FIG. 1 diagrams a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

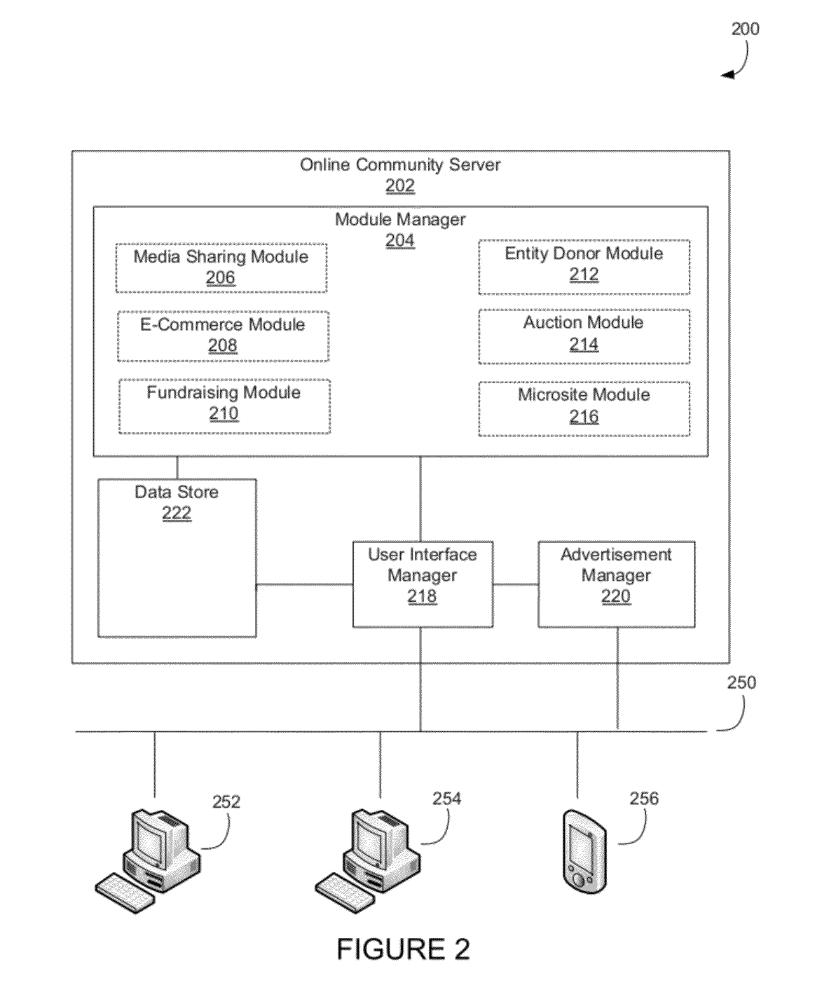

FIG. 2 illustrates an exemplary system diagram in accordance with systems and methods for allocating a common resource based on individual user preferences.

System 200 includes online community server 202. Although online community server 202 is shown as one conceptual entity, online community server 202 may be implemented on one or more computers, such as a distributed network, a cloud network, or any other multi-computer system.

In one or more embodiments, online community server 202 includes module manager 204. In one or more embodiments, modules 206-216 are configured to provide one or more tools and/or services in association with the online community. The modules may be provided by servers managed and/or controlled by the online community as well as by third-party servers. Modules 206-216 include any software tool related to the online community, including generating revenue, advertisement, increasing participation, or any other purpose compatible with systems and methods for allocating a common resource based on individual user preferences. In one or more embodiments, one or more of modules 206-216 provide functionality customized for a charitable purpose.

Exemplary modules 206-216 are shown. Although module manager 204 is shown as a conceptual component of online community server 202, each module may be provided by either the online community server 202 or at least partially by a third-party server, such as its third-party server connected to network 250. For example, a module may include functionality to communicate with a third-party server executing one or more tools and/or services usable with online community server 202. One of ordinary skill in the art will recognize that, while a modular architecture is shown, a modular architecture is not necessary to provide the tools and/or services of online community server 202, and that any architecture may be used without departing from the spirit or the scope of the invention.

For example, exemplary media sharing module 206 provides at least one of photo sharing functionality. Exemplary e-commerce module 208 provides at least one function to facilitate electronic sales of goods and/or services. Exemplary fund raising module 210 provides at least one function to facilitate raising money for a specific cause. Exemplary entity donor module 212 provides at least one function to facilitate donation by a first entity to a tax-exempt entity. Exemplary auction module 214 provides at least one function to facilitate auctioning of goods and/or services. Exemplary microsite module 216 provides at least one function to manage and/or generate one or more recipient member landing pages associated with the online community.

Online community server 202 further includes user interface manager 218. User interface manager 218 provides a user interface to one or more user members. In one or more embodiments, user interface manager 218 provides a user interface to one or more user members over network 250, such Local Area Networks (LAN), Wide Area Networks (WAN), Wireless networks, optical networks, distributed networks, the Internet or any combination thereof.

In one or more embodiments, the user interface is provided to user members on computing devices 252-256, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone.

In one or more embodiments, one or more module 206-216 provides a module user interface that may be integrated into a user interface provided by user interface manager 218. In one or more embodiments, the module user interface is seamlessly presented to the member user in a form displayable on computing devices 252-256. In one or more embodiments, the user interface is presented as a single website within a domain associated with the online community server.

Online community server 202 further includes advertisement manager 220. In one or more embodiments, advertisement manager 220 is connected to network 250. Advertisement manager 220 may communicate with a third-party advertisement server for advertisements to display to generate revenue. Advertising manager 220 may be configured to make decisions regarding advertisement placement to maximize advertising revenue.

Online community server 202 further includes data store 222. Data store 222 is configured to store data regarding member user accounts, recipient user accounts, member user microsite, recipient user microsite, events, opportunities, entity donors, e-commerce, media, participation activities, revenue-generating activities, advertising revenue, and any other data useful for allocating a common resource based on individual user preferences.

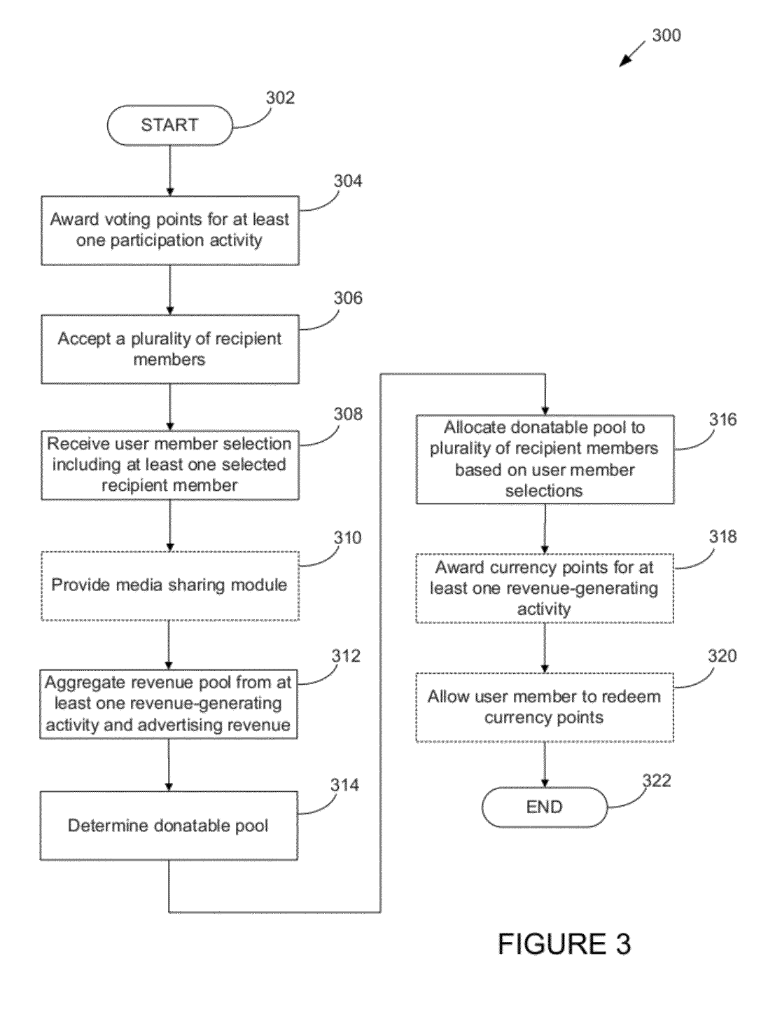

FIG. 3 illustrates a flow chart of an exemplary method for allocating a common resource to at least one recipient member in accordance with systems and methods for allocating a common resource based on individual user preferences. Process 300 begins at step 302.

Processing continues to step 304, where voting points are awarded for at least one participation activity. The voting points are awarded to at least one user member of an online community for at least one participation activity related to the online community. Voting points are provided as an incentive for user members to participate in the online community. Participation in the online community can generate more revenue, such as advertisement revenue. For example, participation generally leads to increased impressions, which also leads to increased click through and sales due to advertising. Furthermore, participation may encourage the use of the online community by non-members as well as increased participation by other members.

In one or more embodiments, the at least one participation activity includes at least one of registration, profile generation, profile completion, providing demographic information, generating content, participating in surveys, referring at least one new user member, referring at least one new recipient member, and any other activity that involves use of the online community by the user member or another party.

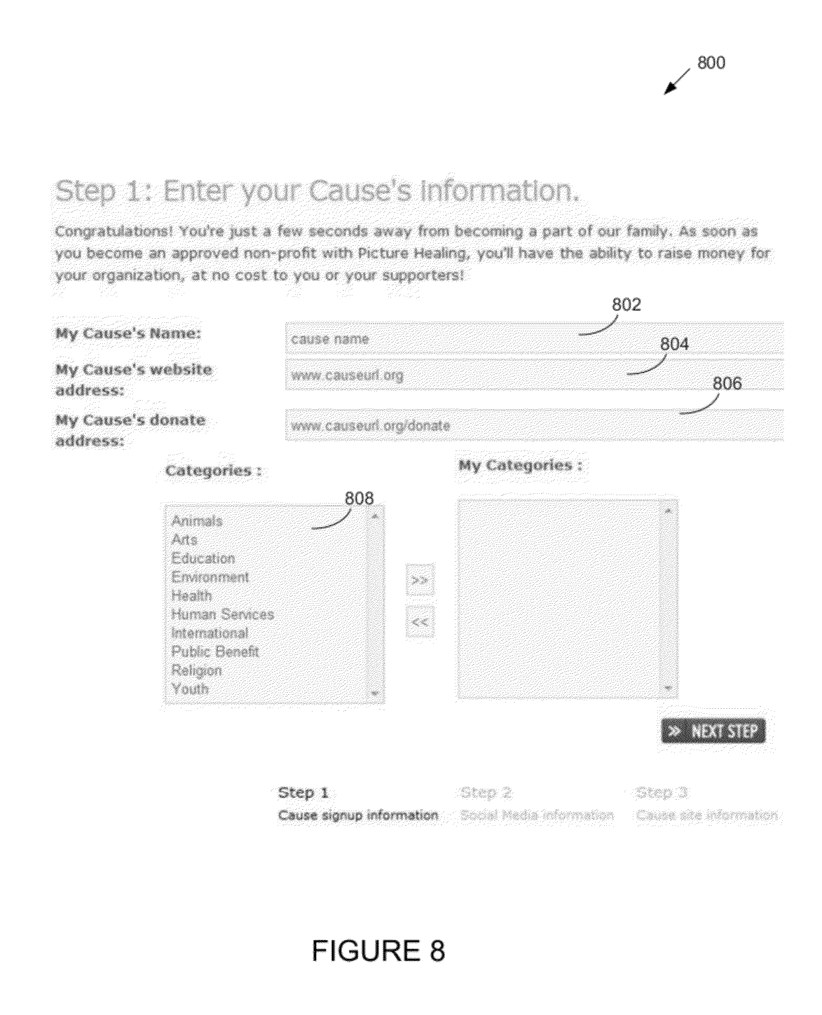

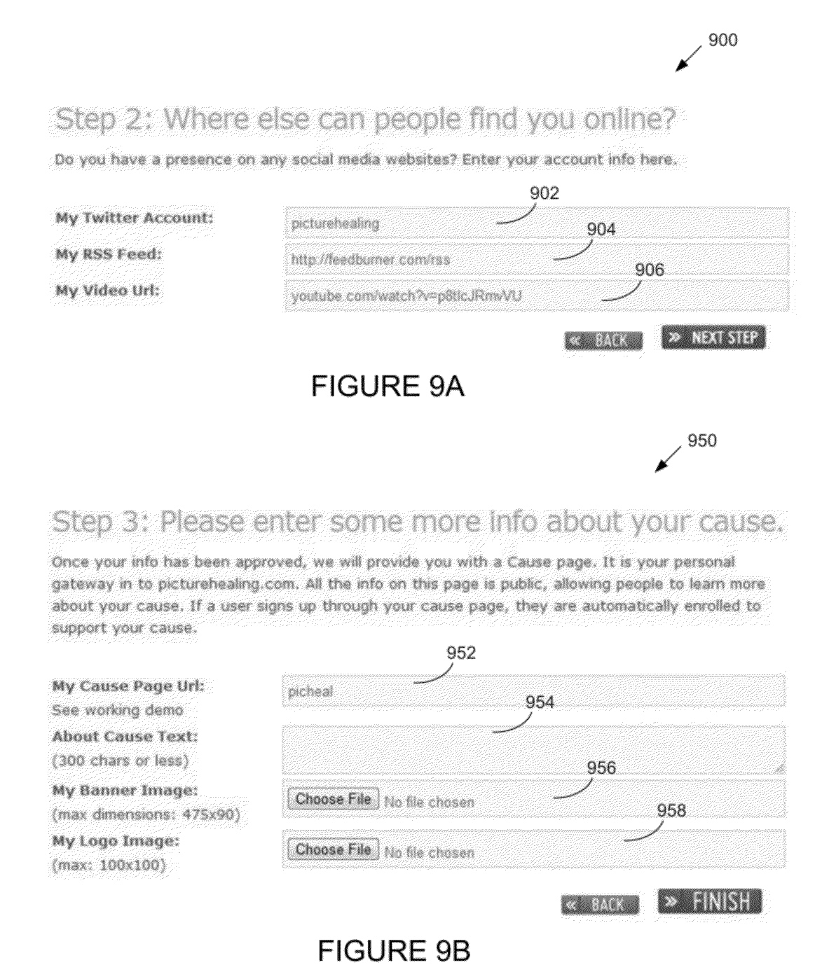

Processing continues to step 306, where a plurality of recipient members is accepted to the online community. In one or more embodiments, each recipient member of the plurality of recipient members is accepted to the online community via a registration process. An exemplary user interface for registering recipient members is described in detail at FIG. 8 and FIGS. 9A-B.

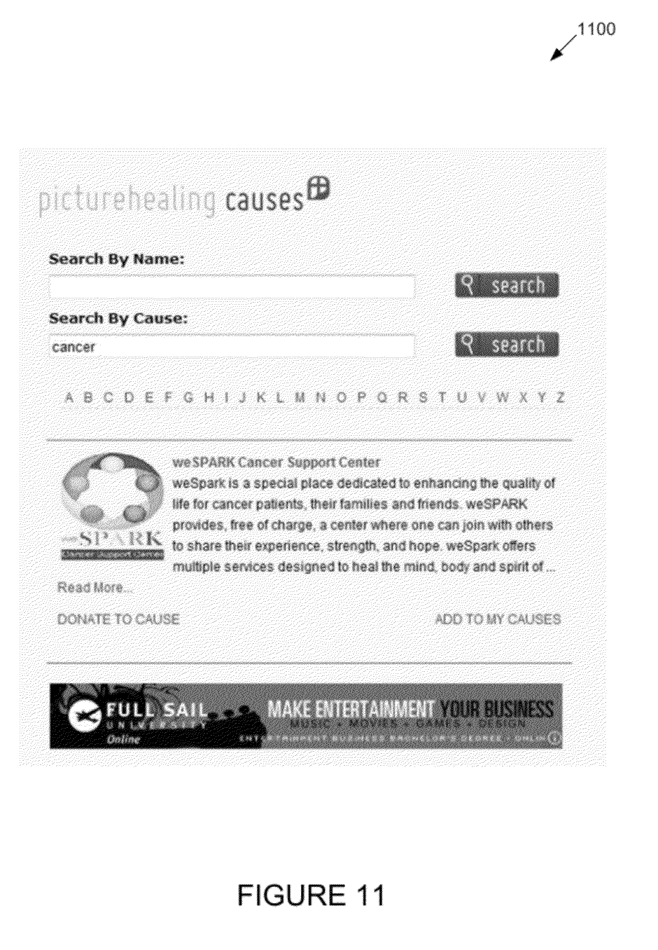

Processing continues to step 308, where at least one user member selection is received. A user member selection includes at least one selected recipient member from the plurality of recipient members. An exemplary user interface for navigating a recipient member directory is further described at FIG. 11. In one or more embodiments, voting points earned by a user member will be used to determine an amount of the donatable pool to be received by the selected recipient members indicated in the user member selection.

In one or more embodiments, the user member selection further includes at least one user-specified allocation between the at least one selected recipient member. In one or more embodiments, the user-specified allocation indicates a proportion of the user member's voting points for each of the selected recipient members of the user member selection.

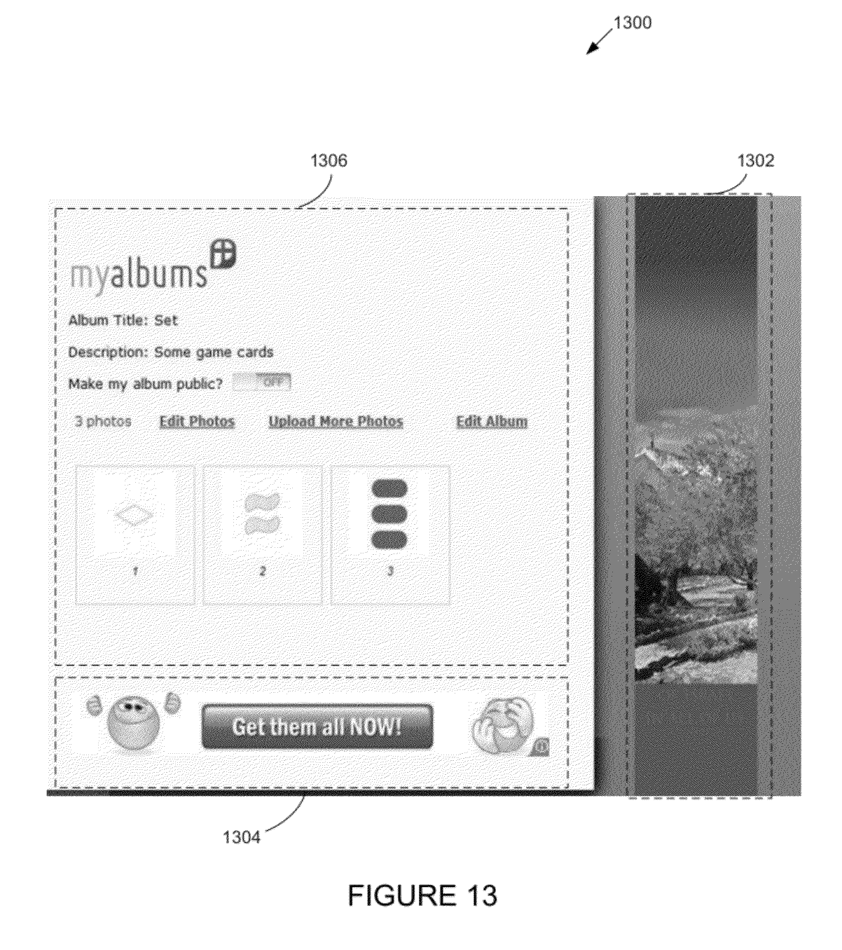

Processing continues to optional step 310, where a media sharing module is provided. In one or more embodiments, the media sharing module is designed to encourage participation and sharing in the online community. An exemplary media sharing module is further described at FIG. 13.

Processing continues to step 312, where a revenue pool is aggregated from at least one revenue-generating activity and any advertising revenue. In one or more embodiments, the advertising revenue includes advertising revenue generated by displaying advertisements in association with the online community. In one or more embodiments, the at least one revenue-generating activity includes at least one of corporate sponsorships, donations, auctions, charity drive participation, raffles, selling merchandise, purchasing merchandise, and any other activity that generates revenue.

Processing continues to step 314, where a donatable pool is determined. The donatable pool includes at least a portion of the revenue pool for allocating to the plurality of recipient members. In one or more embodiments, the donatable pool is at least a portion of the revenue pool after deducting operation costs.

Processing continues to step 316, where the donatable pool is allocated to the plurality of recipient members based on the at least one user member selection. The allocation of the donatable pool may be further based on the at least one user-specified allocation between the at least one selected recipient member of the user. In one or more embodiments, allocating the donatable pool includes determining a recipient point value for each of the plurality of recipient members based on the at least one user-specified allocation and voting points associated with said at least one user member. The donatable pool is allocated to the plurality of recipient members based on the recipient point values and a total number of voting points awarded to all user members. In one or more embodiments, voting points and/or recipient point values are reset to zero periodically, where the donatable pool is determined and allocated each period.

Processing continues to optional step 318, where currency points are awarded to at least one user member for at least one revenue-generating activity related to the online community. In one or more embodiments, the number of currency points awarded to a user member for performing a selected revenue-generating activity is based on the revenue generated by the selected revenue-generating activity. In one or more embodiments, the revenue pool includes at least a portion of the revenue generated by the selected revenue-generating activity.

Processing continues to optional step 320, where at least one user member is allowed to redeem currency points adds at least partial payment for at least one paid service or product available through the online community. The at least one paid service or product may include products and services directly offered by the online community as well as products and services offered by through the online community by one or more user members, one or more recipient members, advertisers, partner organizations, subsidiaries, affiliates, or any other entity offering a product or service through the online community.

Processing continues to step 322, where process 300 terminates.

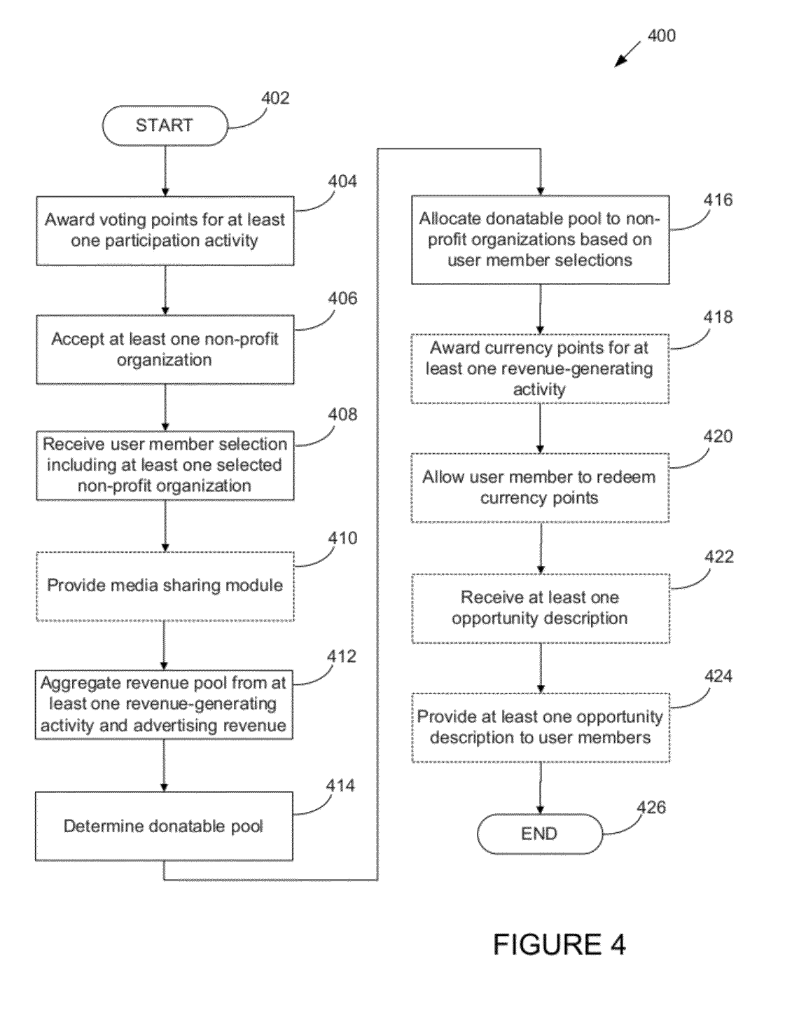

FIG. 4 illustrates a flow chart of an exemplary method for allocating a common resource to at least one non-profit organization in accordance with systems and methods for allocating a common resource based on individual user preferences. Process 400 begins at step 402.

Processing continues to step 404, where voting points are awarded for at least one participation activity. The voting points are awarded to at least one user member of an online community for at least one participation activity related to the online community. Voting points are provided as an incentive for user members to participate in the online community.

Participation in the online community can generate more revenue, such as advertisement revenue. For example, participation generally leads to increased impressions, which also leads to increased click through and sales due to advertising. Furthermore, participation may encourage the use of the online community by non-members as well as increased participation by other members.

In one or more embodiments, the at least one participation activity includes at least one of registration, profile generation, profile completion, providing demographic information, generating content, participating in surveys, referring at least one new user member, referring at least one new non-profit organization, and any other activity that involves use of the online community by the user member or another party.

Processing continues to step 406, where at least one non-profit organization is accepted to the online community. In one or more embodiments, each non-profit organization of the plurality of non-profit organizations is accepted to the online community via a registration process. An exemplary user interface for registering recipient members, including non-profit organizations, is described in detail at FIG. 8 and FIGS. 9A-B. In one or more embodiments, non-profit organizations registered are restricted to tax-exempt entities under section 501(c)(3) of the Internal Revenue Code.

Processing continues to step 408, where at least one user member selection is received. A user member selection includes at least one selected non-profit organization from the plurality of non-profit organizations. An exemplary user interface for navigating a non-profit organization directory is further described at FIG. 11. In one or more embodiments, voting points earned by a user member will be used to determine an amount of the donatable pool to be received by the selected non-profit organizations indicated in the user member selection.

In one or more embodiments, the user member selection further includes at least one user-specified allocation between the at least one selected non-profit organization. In one or more embodiments, the user-specified allocation indicates a proportion of the user member's voting points for each of the selected non-profit organizations of the user member selection.

Processing continues to optional step 410, where a media sharing module is provided. In one or more embodiments, the media sharing module is designed to encourage participation and sharing in the online community. An exemplary media sharing module is further described at FIG. 13.

Processing continues to step 412, where a revenue pool is aggregated from at least one revenue-generating activity and any advertising revenue. In one or more embodiments, the advertising revenue includes advertising revenue generated by displaying advertisements in association with the online community. In one or more embodiments, the at least one revenue-generating activity includes at least one of corporate sponsorships, donations, auctions, charity drive participation, raffles, selling merchandise, purchasing merchandise, and any other activity that generates revenue.

Processing continues to step 414, where a donatable pool is determined. The donatable pool includes at least a portion of the revenue pool for allocating to the plurality of non-profit organizations. In one or more embodiments, the donatable pool is at least a portion of the revenue pool after deducting operation costs.

Processing continues to step 416, where the donatable pool is allocated to the plurality of non-profit organizations based on the at least one user member selection. The allocation of the donatable pool may be further based on the at least one user-specified allocation between the at least one selected non-profit organization of the user. In one or more embodiments, allocating the donatable pool includes determining a recipient point value for each of the plurality of non-profit organizations based on the at least one user-specified allocation and voting points associated with said at least one user member. The donatable pool is allocated to the plurality of non-profit organizations based on the recipient point values and a total number of voting points awarded to all user members. In one or more embodiments, voting points and/or recipient point values are reset to zero periodically, where the donatable pool is determined and allocated each period.

Processing continues to optional step 418, where currency points are awarded to at least one user member for at least one revenue-generating activity related to the online community. In one or more embodiments, the number of currency points awarded to a user member for performing a selected revenue-generating activity is based on the revenue generated by the selected revenue-generating activity. In one or more embodiments, the revenue pool includes at least a portion of the revenue generated by the selected revenue-generating activity.

Processing continues to optional step 420, where at least one user member is allowed to redeem currency points adds at least partial payment for at least one paid service or product available through the online community. The at least one paid service or product may include products and services directly offered by the online community as well as products and services offered by through the online community by one or more user members, one or more non-profit organizations, advertisers, partner organizations, subsidiaries, affiliates, or any other entity offering a product or service through the online community.

Processing continues to optional step 422, where at least one opportunity description is received from at least one non-profit organization. The at least one opportunity description includes at least one description of a non-profit event, donation drive, fundraiser, volunteering opportunity, and any other event or opportunity description. In one or more embodiments, the opportunity description describes a virtual event that is virtually hosted through the online community, including an auction, a charity sale, a donation drive, a live chat, a live broadcast, or any other virtual event.

Processing continues to optional step 424, where the at least one opportunity description is provided to user members through the online community. In one or more embodiments, the online community is configured to accept registrations and/or applications from user members in association with the opportunity described in the opportunity description.

Processing continues to step 426, where process 400 terminates.

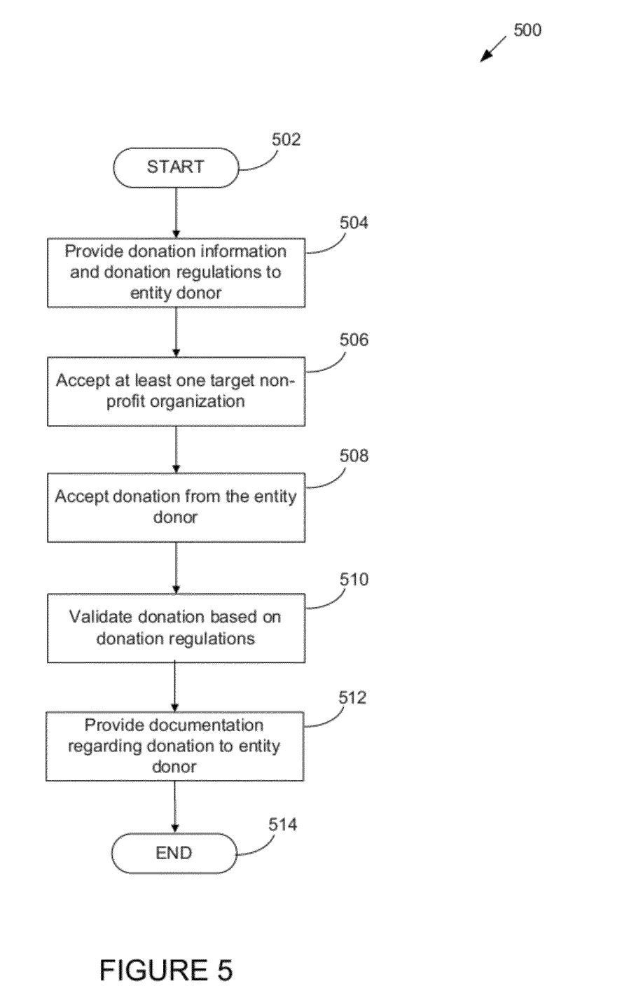

FIG. 5 illustrates a flow chart of an exemplary method for facilitating an entity donor donation in accordance with systems and methods for allocating a common resource based on individual user preferences. Process 500 starts at step 502.

Processing continues to steps 504, where donation information and donation regulations are provided to an entity donor. In one or more embodiments, the at least one target non-profit organization is restricted to tax-exempt entities under section 501(c)(3) of the Internal Revenue Code. The donation information and donation regulations may include information about registered non-profit organizations, donation procedures, Internal Revenue Code information regarding donations, as well as any other information generally related to donations made by an entity donor. As used herein, the term “donation regulations” include any statute, rule, regulation, procedure, or practice related to donations to non-profit organizations, as dictated by any agency, legislative body, or court.

Processing continues to step 506, where at least one target non-profit organization is accepted from the entity donor.

Processing continues to step 508, where a donation is accepted from the entity donor. As used herein, the term “donation” refers to any goods, services or currency currently transferred or promised to a non-profit organization. In one or more embodiments, the online community provides a module configured to process the donation transaction.

Processing continues to step 510, where the donation is validated based on donation regulations. In one or more embodiments, the donation is validated based on the requirements of the Internal Revenue Code. Validation may comprise providing information regarding tax calculations before or after the donation is completed

Processing continues to step 512, where documentation regarding the donation is provided to the entity donor. In one or more embodiments, the documentation includes one or more receipts and/or tax forms related to the donation.

Processing continues to step 514, where process 500 terminates.

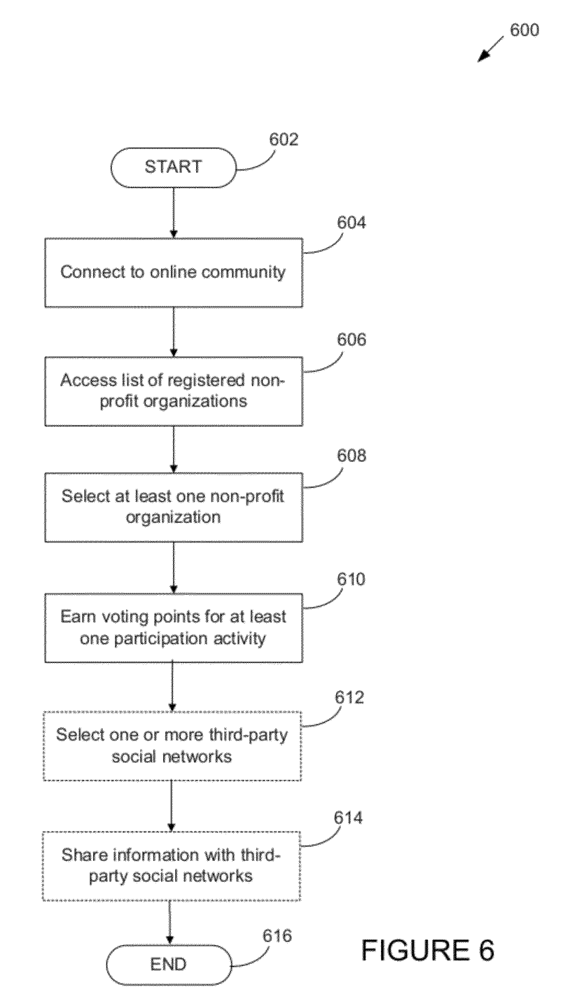

FIG. 6 illustrates a flow chart of an exemplary computer-implemented method for participation in allocating a common resource a plurality of non-profit organizations through an online community in accordance with systems and methods for allocating a common resource based on individual user preferences. In one or more embodiments, process 600 is encoded as computer-readable instructions in a computer-readable medium. The computer-readable instructions are executable on a computing device with a processor, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone. Process 600 begins at step 602.

Processing continues to step 604, where the computing device connects to the online community. For example, the computing device may connect to a URL associated with a domain of the online community. In one or more embodiments, authentication procedures are performed to login a user member of the online community.

Processing continues to step 606, where a list of registered non-profit organizations registered with the online community is accessed. The list may be accessed in its entirety or via a browsing or search interface. An exemplary user interface for navigating a non-profit organization directory is further described at FIG. 11.

Processing continues to step 608, where at least one non-profit organization is selected from the registered non-profit organizations. In one or more embodiments, voting points earned by a user member will be used to determine an amount of the donatable pool to be received by the selected non-profit organizations.

Processing continues to step 610, where voting points are earned for at least one participation activity related to the online community. The voting points are earned by the user member for at least one participation activity related to the online community. Voting points are provided as an incentive to user member to participate in the online community. Participation in the online community can generate more revenue, such as advertisement revenue. For example, participation generally leads to increased impressions, which also leads to increased click through and sales due to advertising. Furthermore, participation may encourage the use of the online community by non-members as well as increased participation by other members.

In one or more embodiments, the at least one participation activity includes at least one of registration, profile generation, profile completion, providing demographic information, generating content, participating in surveys, referring at least one new user member, referring at least one new non-profit organization, and any other activity that involves use of the online community by the user member or another party.

The voting points are used to determine allocation of the donatable pool for donation to at least one of the registered non-profit organizations. The donatable pool includes at least a portion of the revenue pool generated by revenue-generating activities associated with the online community, as well as any advertisement revenue generated by displaying advertisements in association with the online community.

Processing continues to optional step 612, where one or more third-party social media networks are selected. Third-party social media networks include any social media network over which information may be shared by a user of the third-party social media network to other members of the third-party social media network.

Processing continues to optional step 614, where information is shared with the third-party social media networks. In one or more embodiments, voting points are awarded for allowing the online community to share information with one or more third-party social media networks. Sharing information over one or more third-party social media networks may encourage the use of the online community by non-members as well as increased participation by other members.

Alternatively in place of steps 612 and 614 information may be shared via email or other electronic means such as text messaging, MMS or other suitable mechanisms for distributing digital data over a computer network.

Processing continues to step 616, where process 600 terminates.

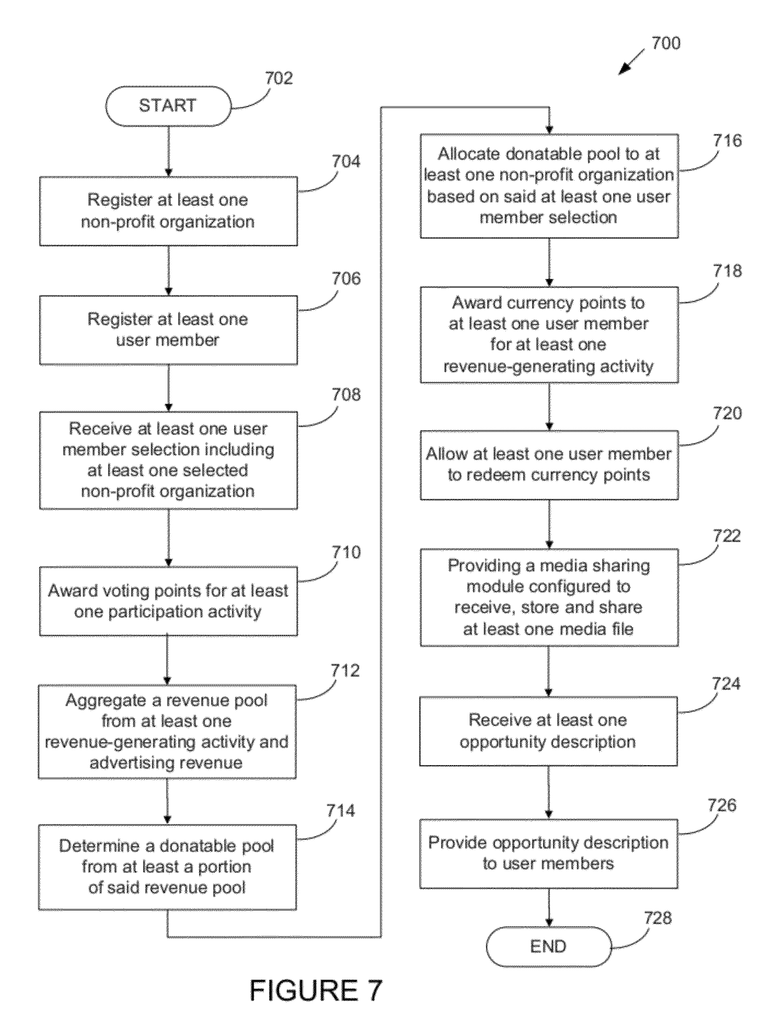

FIG. 7 illustrates a flow chart of an exemplary method for enabling individuals to collectively contribute to non-profit organizations in accordance with systems and methods for allocating a common resource based on individual user preferences. Process 700 begins at step 702.

Processing continues to step 704, where at least one non-profit organization is registered to the online community. In one or more embodiments, the online community is configured to enable at least one user member to contribute to the at least one non-profit organization. An exemplary user interface for registering recipient members, including non-profit organizations, is described in detail at FIG. 8 and FIGS. 9A-B. In one or more embodiments, non-profit organizations registered are restricted to tax-exempt entities under section 501(c)(3) of the Internal Revenue Code.

Processing continues to step 706, where at least one user member is registered. An account of the at least one user member is used to keep track of the members selected non-profit organizations, voting points earned for participation activities, and currency points earned for revenue-generating activities.

Processing continues to step 708, where at least one user member selection is received. The user member selection includes at least one selected non-profit organization. An exemplary user interface for navigating a non-profit organization directory is further described at FIG. 11. In one or more embodiments, voting points earned by a user member will be used to determine an amount of the donatable pool to be received by the selected non-profit organizations indicated in the user member selection.

In one or more embodiments, the user member selection further includes at least one user-specified allocation between the at least one selected non-profit organization. In one or more embodiments, the user-specified allocation indicates a proportion of the user member's voting points for each of the selected non-profit organizations of the user member selection.

Processing continues to step 710, where voting points are awarded for at least one participation activity. The voting points are awarded to at least one user member of an online community for at least one participation activity related to the online community. Voting points are provided as an incentive for user members to participate in the online community. Participation in the online community can generate more revenue, such as advertisement revenue. For example, participation generally leads to increased impressions, which also leads to increased click through and sales due to advertising. Furthermore, participation may encourage the use of the online community by non-members as well as increased participation by other members.

In one or more embodiments, the at least one participation activity includes at least one of registration, profile generation, profile completion, providing demographic information, generating content, participating in surveys, referring at least one new user member, referring at least one new non-profit organization, and any other activity that involves use of the online community by the user member or another party.

Processing continues to step 712, where a revenue pool is aggregated from at least one revenue-generating activity and any advertising revenue. In one or more embodiments, the advertising revenue includes advertising revenue generated by displaying advertisements in association with the online community. In one or more embodiments, the at least one revenue-generating activity includes at least one of corporate sponsorships, donations, auctions, charity drive participation, raffles, selling merchandise, purchasing merchandise, and any other activity that generates revenue.

Processing continues to step 714, where a donatable pool is determined. The donatable pool includes at least a portion of the revenue pool for allocating to the plurality of non-profit organizations. In one or more embodiments, the donatable pool is at least a portion of the revenue pool after deducting operation costs.

Processing continues to step 716, where the donatable pool is allocated to the plurality of non-profit organizations based on the at least one user member selection. The allocation of the donatable pool may be further based on the at least one user-specified allocation between the at least one selected non-profit organization of the user. In one or more embodiments, allocating the donatable pool includes determining a recipient point value for each of the plurality of non-profit organizations based on the at least one user-specified allocation and voting points associated with said at least one user member. The donatable pool is allocated to the plurality of non-profit organizations based on the recipient point values and a total number of voting points awarded to all user members. In one or more embodiments, voting points and/or recipient point values are reset to zero periodically, where the donatable pool is determined and allocated each period.

Processing continues to optional step 718, where currency points are awarded to at least one user member for at least one revenue-generating activity related to the online community. In one or more embodiments, the number of currency points awarded to a user member for performing a selected revenue-generating activity is based on the revenue generated by the selected revenue-generating activity. In one or more embodiments, the revenue pool includes at least a portion of the revenue generated by the selected revenue-generating activity.

Processing continues to optional step 720, where at least one user member is allowed to redeem currency points adds at least partial payment for at least one paid service or product available through the online community. The at least one paid service or product may include products and services directly offered by the online community as well as products and services offered by through the online community by one or more user members, one or more non-profit organizations, advertisers, partner organizations, subsidiaries, affiliates, or any other entity offering a product or service through the online community.

Processing continues to step 722, where a media sharing module is provided. In one or more embodiments, the media sharing module is designed to encourage participation and sharing in the online community. An exemplary media sharing module is further described at FIG. 13.

Processing continues to optional step 724, where at least one opportunity description is received from at least one non-profit organization. The at least one opportunity description includes at least one description of a non-profit event, donation drive, fundraiser, volunteering opportunity, and any other event or opportunity description. In one or more embodiments, the opportunity description describes a virtual event that is virtually hosted through the online community, including an auction, a charity sale, a donation drive, a live chat, a live broadcast, or any other virtual event.

Processing continues to optional step 726, where the at least one opportunity description is provided to user members through the online community. In one or more embodiments, the online community is configured to accept registrations and/or applications from user members in association with the opportunity described in the opportunity description.

Processing continues to step 728, where process 700 terminates.

FIG. 8 illustrates an exemplary user interface for registering a recipient member in accordance with systems and methods for allocating a common resource based on individual user preferences.

User interface 800 may be provided to a user over a network, such Local Area Networks (LAN), Wide Area Networks (WAN), Wireless networks, optical networks, distributed networks, the Internet or any combination thereof. In one or more embodiments, user interface 800 is displayable on a computing device, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone.

User interface 800 may be provided to an authorized user associated with the recipient member. In one or more embodiments, the recipient member is a non-profit organization. User interface 800 may ensure that a potential recipient member is a tax-exempt entity under section 501(c)(3) of the Internal Revenue Code. For example, a Federal Employer ID Number (FEIN) may be required to register a non-profit organization.

User interface 800 includes name field 802 for entering a recipient member's name. User interface 800 further includes an address field 804 for entering an address associated with the recipient member. In one or more embodiments, address field 804 is configured to accept a web address. User interface 800 further includes donation address field 806 for entering an address configured to accept resources from another source other than the online community. In one or more embodiments, donation address field 806 is configured to accept a web address.

In order more embodiments, user interface 800 further includes one or more category selection tool 808. Category selection tool 808 may include a list, one or more fields, a plurality of radio buttons, a plurality of check boxes, a pulldown menu, or any other method of selecting one or more categories.

FIGS. 9A-9B illustrate an exemplary user interface for registering a recipient member in accordance with systems and methods for allocating a common resource based on individual user preferences.

User interface 900 may be provided to an authorized user associated with the recipient member. In one or more embodiments, the recipient member is a non-profit organization. User interface 900 may ensure that a potential recipient member is a tax-exempt entity under section 501(c)(3) of the Internal Revenue Code. For example, a Federal Employer ID Number (FEIN) may be required to register a non-profit organization.

User interface 900 may include one or more social media selection tools 902-906. Social media selection tools 902-906 may include a list, one or more fields, a plurality of radio buttons, a plurality of check boxes, a pulldown menu, or any other method of selecting one or more third-party social media networks. Third-party social media networks include any social media network over which information may be shared by a user of the third-party social media network to other members of the third-party social media network. In one or more embodiments, user interface 900 prompts an authorized user third-party social media network account information associated with the recipient member. The third-party social media in a network account information may be authenticated.

User interface 950 may be provided to an authorized user associated with the recipient member. In one or more embodiments, the recipient member is a non-profit organization. User interface 950 may ensure that a potential recipient member is a tax-exempt entity under section 501(c)(3) of the Internal Revenue Code. For example, a Federal Employer ID Number (FEIN) may be required to register a non-profit organization.

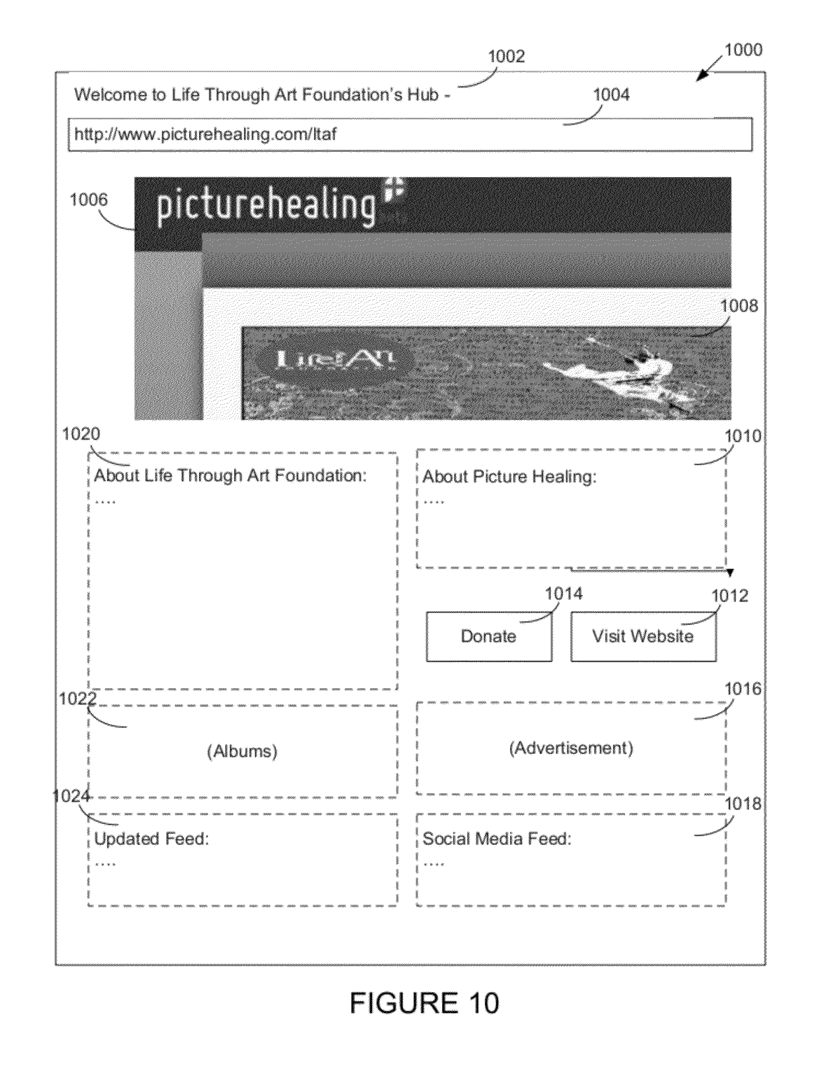

In one or more embodiments, user interface 950 includes microsite ID field 952. Microsite ID field 952 accepts a unique identifier to associate with the recipient member for generating a microsite associated with the online community. In one or more embodiments, the microsite is a landing page within a domain provided by the online community. FIG. 10 illustrates an exemplary microsite in more detail.

User interface 950 may further include recipient detail fields 954-958. Recipient detail fields 954-958 may include a list, one or more fields, a plurality of radio buttons, a plurality of check boxes, a pulldown menu, or any other method of specifying additional details about a recipient member. In one or more embodiments, recipient detail fields 954-958 are configured to accept data including one or more summaries, logos, banners, video, text, or other media describing the recipient member. In one or more embodiments, information provided in recipient detail fields 554-958 is usable to customize a microsite associated with the recipient member.

FIG. 10 illustrates an exemplary microsite for a recipient member in accordance with systems and methods for allocating a common resource based on individual user preferences.

In one or more embodiments, microsite 1000 is a webpage associated with one in recipient member of the online community. In one or more embodiments, at least one recipient member is a tax-exempt entity under section 501(c)(3) of the Internal Revenue Code.

In one or more embodiments, microsite 1000 is a landing page hosted by the online community. The microsite address 1004 may share a domain with the online community. Microsite 1000 may be template driven based on information provided about a recipient member, such as registration information provided in FIG. 8 and FIGS. 9A-9B. In order more embodiments, various levels of customization of microsite 1000 may be provided to a recipient member. In one or more embodiments, a recipient member may purchase or otherwise earn an elevated account status. An elevated account status may have reduced or removed advertisements, additional customization levels, additional contents, or any other benefit.

Microsite 1000 may include title 1002. In one or more embodiments, a recipient member's name may be included in title 1002. Microsite 1000 may further include one or more names, logos, graphics, icons, or other marks 1006 associated with the online community. Microsite 1000 may further include one or more names, logos, graphics, icons, or other marks 1008 associated with the recipient member.

Microsite 1000 may further include one or more online community description 1010. Online community description 1010 may include text, images, video, or any other media describing the online community. In one or more embodiments, the online community enables individuals to collectively contribute to non-profit organizations in accordance with systems and methods for allocating a common resource based on individual user preferences.

Microsite 1000 may further provide an external site interface 1012. In one or more embodiments, external site interface 1012 opens a link to an address, such as an address specified in address field 804.

Microsite 1000 may further provide a donation interface 1014. Donation interface 1014 allows for the independent contribution of resources to the recipient member. In one or more embodiments, donation interface 1014 opens a link to a donation address, such as a donation address specified in donation address field 806.

Microsite 1000 may further include at least one advertisement 1016. In one or more embodiments, the advertising revenue includes advertising revenue generated by displaying advertisement 1016 in association with the online community.

Microsite 1000 may further include one or more recipient member descriptions 1018-1024. Recipient member descriptions 1018-1024 include text, images, video, or any other media describing the online community.

In one or more embodiments, recipient member descriptions 1018-1024 include media albums 1022. The media albums may contain media, such as audio, video, and/or photographs associated with the recipient member. In one or more embodiments, the media albums may correspond to one or more events associated with the recipient member.

FIG. 11 illustrates an exemplary user interface for navigating a recipient member directory in accordance with systems and methods for allocating a common resource based on individual user preferences.

User interface 1100 may be provided to a user over a network, such Local Area Networks (LAN), Wide Area Networks (WAN), Wireless networks, optical networks, distributed networks, the Internet or any combination thereof. In one or more embodiments, user interface 1100 is displayable on a computing device, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone.

User interface 1100 allows for searching and/or browsing for one or more recipient members. In one or more embodiments, the recipient members are tax-exempt entities under section 501(c)(3) of the Internal Revenue Code. For example, searching and/or browsing may be performed by subject, name, or any other search criteria. User interface 1100 may be used by a member user to choose at least one user member selection. In one or more embodiments, user interface 1100 provides a link to additional information associated with a recipient member. In order more embodiments, the additional information is a microsite.

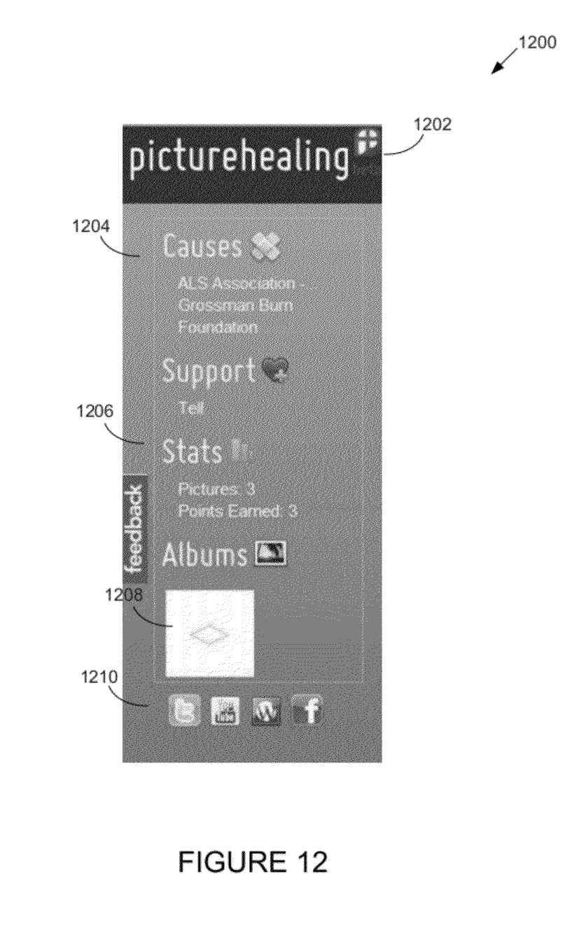

FIG. 12 illustrates an exemplary user interface provided to a user member in accordance with systems and methods for allocating a common resource based on individual user preferences.

A user member selection includes at least one selected non-profit organization from the plurality of non-profit organizations. An exemplary user interface for navigating a non-profit organization directory is further described at FIG. 11.

User interface 1200 may be provided to a user over a network, such Local Area Networks (LAN), Wide Area Networks (WAN), Wireless networks, optical networks, distributed networks, the Internet or any combination thereof. In one or more embodiments, user interface 1200 is displayable on a computing device, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone. In one or more embodiments, user interface 1200 is displayable as a menu.

In one or more embodiments, user interface 1200 is associated with an online community enabling individuals to collectively contribute to non-profit organizations in accordance with systems and methods for allocating a common resource based on individual user preferences.

User interface 1200 may include one or more names, logos, graphics, icons, or other marks 1202 associated with the online community.

User interface 1200 may further display at least one selected recipient member 1204. In one or more embodiments, the display of the at least one selected recipient member 1204 includes one or more links to at least one microsite associated with the at least one selected recipient member 1204. In one or more embodiments, the at least one selected recipient member 1204 includes at least one non-profit organization.

User interface 1200 may further include at least one user member statistic 1206. The at least one user member statistic 1206 may include any data associated with the user member, such as any data related to revenue-generating activities, participation activities, or any other data.

In one or more embodiments, user interface 1200 further includes one or more media albums 1208. Media albums 1208 may be associated with participation activity. For example, participation activities may include at least one of uploading media, sharing media and managing media. Although media albums 1208 are shown, one of ordinary skill in the art will recognize that information about any participation activity related to the online community, including participation activity used to generate revenue through advertising, may be displayed without departing from the spirit or the scope of the invention.

In one or more embodiments, user interface 1200 further includes one or more social media tools 1210. Social media tools 1210 are configured to share online community information with one or more third-party social media networks. Third-party social media networks include any social media network over which information may be shared by a user of the third-party social media network to other members of the third-party social media network. In one or more embodiments, voting points are awarded for allowing the online community to share information with one or more third-party social media networks. Sharing information over one or more third-party social media networks may encourage the use of the online community by non-members as well as increased participation by other members.

FIG. 13 illustrates an exemplary media sharing module in accordance with systems and methods for allocating a common resource based on individual user preferences.

User interface 1300 may be provided to a user over a network, such Local Area Networks (LAN), Wide Area Networks (WAN), Wireless networks, optical networks, distributed networks, the Internet or any combination thereof. In one or more embodiments, user interface 1300 is displayable on a computing device, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone.

User interface 1300 may include at least one advertisement 1302-1304. In one or more embodiments, the advertising revenue includes advertising revenue generated by displaying advertisements 1302-1304 in association with the online community.

User interface 1300 further includes at least one module 1306. In one or more embodiments, module 1306 is configured to provide one or more tools and/or services in association with the online community. The modules may be provided by servers managed and/or controlled by the online community as well as by third-party servers. Module 1306 may include any software tool related to at least one of the online community, generating revenue, advertisement, increasing participation, or any other purpose compatible with systems and methods for allocating a common resource based on individual user preferences. In one or more embodiments, module 1306 provides at least one of photo sharing functionality, a directory, microsite management, individual landing pages, e-commerce, event management, opportunity management, entity donation, fundraising management, gift-card sales, auctions, and any other functionality compatible with systems and methods for allocating a common resource based on individual user preferences. In one or more embodiments, module 1306 provides functionality customized for a charitable purpose.

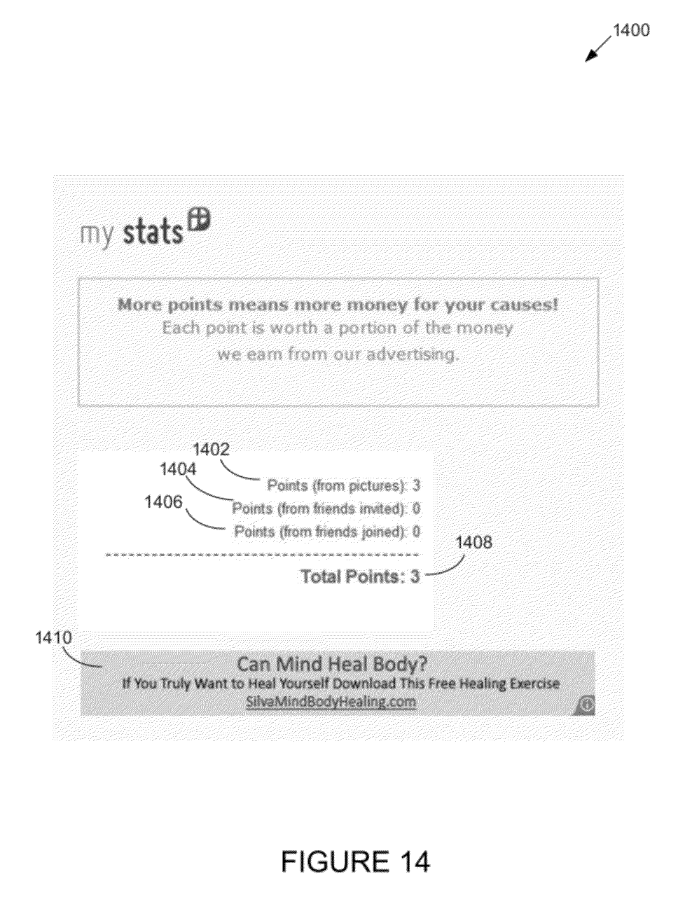

FIG. 14 illustrates an exemplary display showing user member participation information in accordance with systems and methods for allocating a common resource based on individual user preferences.

Display 1400 may be provided to a user over a network, such Local Area Networks (LAN), Wide Area Networks (WAN), Wireless networks, optical networks, distributed networks, the Internet or any combination thereof. In one or more embodiments, display 1400 is displayable on a computing device, such as a general-purpose computer, a laptop, a PDA, a smart phone, a cellular telephone, a tablet computer, or any other computing device, including but not limited to a mobile device, or any computational device not yet developed. In one or more embodiments, the computer-readable instructions are provided as a mobile app for a smart phone.

Display 1400 includes an accounting of total voting points 1408 of a user. In one or more embodiments, display 1400 further includes a breakdown of total voting points 1408 by voting points earned for at least one participation activity 1402-1406. In one or more embodiments, display 1400 further includes at least one advertisement 1410. Advertisement 1410 may generate advertising revenue by displaying advertisement 1410 in association with the online community.

While the invention herein disclosed has been described by means of specific embodiments and applications thereof, numerous modifications and variations could be made thereto by those skilled in the art without departing from the scope of the invention set forth in the claims.

What is claimed is:

1. A computer-readable medium comprising computer-readable instructions for allocating a common resource based on individual user preferences, wherein execution of said computer-readable instructions by one or more processors causes said one or more processors to carry out steps comprising:
awarding voting points to at least one user member of an online community for at least one participation activity related to said online community;
accepting a plurality of recipient members to said online community;
receiving at least one user member selection comprising at least one selected recipient member;
aggregating a revenue pool from at least one revenue-generating activity and any advertising revenue;
determining a donatable pool, wherein said donatable pool comprises at least a portion of said revenue pool for allocating to said plurality of recipient members;
allocating said donatable pool to said plurality of recipient members based on said at least one user member selection.

2. The computer-readable medium of claim 1, wherein said at least one user member selection further comprises at least one user-specified allocation between said at least one selected recipient member, wherein allocating said donatable pool is further based on said at least one user-specified allocation.

3. The computer-readable medium of claim 2, wherein said allocating said donatable pool comprises determining a recipient point value for each of said plurality of recipient members based on said at least one user-specified allocation and voting points associated with said at least one user member, wherein said donatable pool is allocated to said plurality of recipient members based on said recipient point values and a total number of voting points awarded.

4. The computer-readable medium of claim 1, wherein said computer-readable instructions further comprise:
awarding currency points to said at least one user member of said online community for at least one revenue-generating activity related to said online community, wherein a number of currency points awarded for a selected revenue-generating activity is based on revenue generated by said selected revenue-generating activity;
allowing said at least one user member to redeem said currency points as at least partial payment for at least one paid service or product available through said online community.

5. The computer-readable medium of claim 1, wherein said at least one revenue-generating activity comprises at least one of corporate sponsorships, donations, auctions, charity drive participation, raffles, selling merchandise, and purchasing merchandise.

6. The computer-readable medium of claim 1, wherein said at least one participation activity comprises at least one of registration, profile generation, profile completion, providing demographic information, generating content, participating in surveys, referring at least one new user member, and referring at least one new recipient member.

7. The computer-readable medium of claim 1, wherein said online community comprises a media sharing network, and wherein said steps further comprise:
providing a media sharing module through said online community, wherein said media sharing module is configured to perform the steps of:
receiving at least one media file from a selected user member;
storing said at least one media file in association with said selected user member; and
providing said at least one media file in association with said selected user member.

8. The computer-readable medium of claim 7, wherein said at least one media file comprises at least one photograph.

9. The computer-readable medium of claim 8, wherein said at least one participation activity comprises at least one of uploading media, sharing media and managing media.

10. The computer-readable medium of claim 8, wherein said at least one revenue-generating activity comprises at least one of selling a representation of one or more selected media files, purchasing a representation of said one or more selected media files, selling merchandise customized with said one or more selected media files, and purchasing merchandise customized with said one or more selected media files.

11. The computer-readable medium of claim 8, wherein said at least one participation activity comprises associating one or more selected media files with one or more recipient members.

12. The computer-readable medium of claim 1, wherein said steps further comprise providing at least one microsite for at least one of said plurality of recipient members.

13. The computer-readable medium of claim 1, wherein said steps further comprise providing at least one microsite for at least one user member.

14. The computer-readable medium of claim 1, wherein said plurality of recipient members comprises at least one non-profit organization, wherein said at least one selected recipient member comprises at least one selected non-profit organization, and wherein said online community is configured to enable said user members to contribute to said at least one selected non-profit organization.

15. The computer-readable medium of claim 14, wherein said steps further comprise:
receiving at least one opportunity description from said at least one non-profit organization, wherein said at least one opportunity description comprise at least one of non-profit events, donation drives, fundraisers and volunteering opportunities; and
providing said at least one opportunity description to said user members through said online community.

16. The computer-readable medium of claim 14, wherein said online community is configured to enable said user members to contribute to said at least one selected non-profit organization by at least one of direct donation, volunteering, viewing advertising content provided through said online community, engaging in said at least one participation activity, and engaging in said at least one revenue-generating activity.

17. The computer-readable medium of claim 14, wherein said steps further comprise:
providing donation information and donation regulations to at least one entity donor;
accepting at least one target non-profit organization from said at least one entity donor;
accepting at least one donation to said at least one target non-profit organization;
validating said at least one donation based on said donation regulations; and
providing documentation regarding said at least one donation to said at least one entity donor.

18. A computer-readable medium for participation in allocating a common resource to a plurality of non-profit organizations through online community comprising computer-readable instructions, wherein execution of said computer-readable instructions by one or more processors causes said one or more processors to carry out steps comprising:
connecting to an online community;
accessing a list of registered non-profit organizations registered with said online community;
selecting at least one selected non-profit organization from said registered non-profit organizations; and
earning voting points for at least one participation activity related to said online community;
wherein said voting points are used to determine an allocation of a donatable pool for donation to at least one of said registered non-profit organizations, wherein said donatable pool comprises at least a portion of a revenue pool generated by revenue-generating activities associated with said online community.

19. The computer-readable medium of claim 18, wherein the steps further comprise selecting one or more third-party social media network, wherein information is shared between said online community and said one or more third-party social media network.

20. A computer-implemented method for enabling individuals to collectively contribute to non-profit organizations, comprising the steps of:
registering at least one non-profit organization to an online community configured to enable at least one user member to contribute to said at least one non-profit organization;
registering said at least one user member;
receiving at least one user member selection comprising at least one selected non-profit organization;
awarding voting points to said at least one user member for at least one participation activity related to said online community, wherein said at least one participation activity comprises at least one of registration, profile generation, profile completion, providing demographic information, generating content, participating in surveys, referring at least one new user member, and referring at least one new non-profit organization;
aggregating a revenue pool from at least one revenue-generating activity and any advertising revenue;
determining a donatable pool, wherein said donatable pool comprises at least a portion of said revenue pool for allocating to said at least one non-profit organization;
allocating said donatable pool to said at least one non-profit organization based on said at least one user member selection;
awarding currency points to said at least one user member for at least one revenue-generating activity related to said online community, wherein a number of currency points awarded for a selected revenue-generating activity is based on revenue generated by said selected revenue-generating activity, wherein said at least one revenue-generating activity comprises at least one of corporate sponsorships, donations, auctions, charity drive participation, raffles, selling merchandise, and purchasing merchandise;
allowing said at least one user member to redeem said currency points as at least partial payment for at least one paid service or product available through said online community;
providing a media sharing module through said online community, wherein said media sharing module is configured to receive, store and share at least one media file associated with at least one of said at least one user member or non-profit organization, wherein said at least one participation activity further comprises at least one of uploading media, sharing media and managing media;
receiving at least one opportunity description from said at least one non-profit organization, wherein said at least one opportunity description comprise at least one of non-profit events, donation drives and volunteering opportunities; and
providing said at least one opportunity description to said user members through said online community.
